(19) United States
(12) Patent Application Publication
(10) Pub. No.: US 2013/0101710 A1
(43) Pub. Date: Apr. 25, 2013

(54) Producing Infused Beverages Using Ultrasound Energy

(71) Applicant: Bobak Ha'Eri, Wayzata, MN (US)

(72) Inventor: Bobak Ha'Eri, Wayzata, MN (US)

(73) Assignee: Bobak Ha'Eri, Wayzata, MN (US)

(21) Appl. No.: 13/450,966

(22) Filed: Apr. 19, 2012

Related U.S. Application Data
(60) Provisional application No. 61/477,403, filed on Apr. 20, 2011.

(51) Int. Cl. A47J 31/00

(52) U.S. Cl. CPC A47J 31/00
USPC 426/238; 99/279; 99/286; 99/298

(57) ABSTRACT

Infused beverages are produced using ultrasound energy. The device delivers ultrasound energy to the target, producing infused beverages that may have more flavor and smoothness and are safer than conventionally produced infused beverages. The process of infusing one or more ingredients with a beverage comprises placing the ingredients with beverage, placing an ultrasound transducer at a predetermined location from the ingredients, and sonicating the ingredients by applying ultrasound energy from the ultrasound transducer. The process can comprise the additional step of pulverizing the ingredient. The steps can occur in any order, including partially or completely simultaneously.

### BACKGROUND

Current methods for infusing beverages have been around for thousands of years: flavorants and target beverage are placed together, and the combination is left to steep for however long as needed to extract the desired level of flavor.

This method has several disadvantages. The duration needed for steeping can vary based on the density and make-up of the flavorant. For example, tea leaves take a short amount of time to steep, while others, including coconuts, can take months. The smoothness and quality of the resulting beverage can depend on the amount of time spent steeping, which in turn can be affected by environmental factors, for example temperature. Also, the nature of the beverage or ingredient can also affect smoothness, for example alcohol. The process, and particularly the durations involved, can lead to health issues if bacteria, parasites, and other potentially harmful microorganisms develop in the infused beverage.

A popular way to speed up the infusion process is with heat. Heat may also sanitize a beverage. However heat has its own disadvantages. Notably, heat does not speed up all infusions, and there are flavorants that can have their flavor negatively altered by heat. Heat can also cause a beverage to be too hot to safely or comfortably drink, particularly if employed to sanitize a beverage. Also, overheating can denature ingredients or beverage.

Outside the market for brewing tea and coffee, little work has been done in speeding up the beverage infusing process. To speed up the process, many infused beverages, including alcoholic beverages, are infused with inferior, mostly artificial syrups that do not match the quality found in home-made, long duration infusions using authentic or natural ingredients.

### SUMMARY

The present device and method are directed towards apparatus and method for infusing beverage and ingredient that satisfies the need for infusions that are faster, with increased flavor, smoothness and safety. In the case of ingredients containing caffeine, the present device and method may increase the amount of caffeine infused into the resulting beverage. In the case of alcohol-based beverages, the present device and method may make them stronger. In accordance with one embodiment, the apparatus comprises an ultrasound tip, ultrasound horn and ultrasound transducer, for using ultrasound energy to sonicate one or more target ingredients and beverages, and a generator for providing energy to power the ultrasound transducer. Sonication delivers ultrasound energy which vibrates and cavitates the ingredient and beverage; this effect breaks up the ingredients and infuses the ingredient and beverage. Apparatuses and methods in accordance with the present invention may meet the above-mentioned needs and also provide additional advantages and improvements that will be recognized by those skilled in the art upon review of the present disclosure.

The present device and method may create infused beverages quickly, consistently in relation to quality and smoothness of end product, and that sanitizes the beverage of potentially harmful bacteria, parasites, and other potentially harmful microorganisms.

The present device and method causes reduced separation of ingredients. Beverage and ingredients are infused together.

The present device and method may speed up the infusion of beverages without limitation to the selected ingredient for infusion, or altering the flavor due to use of heat. This method and device does not cause a beverage to be too hot to safely or comfortably drink, however the ultrasound energy may sanitize the target beverage.

The present device and method may speed up commercial manufacture of infused beverages. The device and methods ability to quickly infuse a variety of ingredients may permit a commercially viable method for using authentic or natural ingredients.

In the steeping of coffee and tea, longer duration may create in increase in the amount of caffeine added to a beverage. The present device and method may speed up and increase the amount of caffeine infused into the resulting beverage. The ability to increase the amount of caffeine is not limited to coffee and tea, but may also increase the amount of caffeine in other caffeinated ingredients.

The present device and method may create stronger alcoholic beverages that are also better infused with stronger, more even flavor than any traditional method currently used. Ultrasound energy may create smoother alcoholic beverages that are less harsh and less bitter.

The ultrasound transducer can comprise a distal end with radiation surface, including the form of a Langevin transducer. Such a design permits more focused and targeted delivery of ultrasound energy. The ultrasound transducer can further comprise a distal end with radiation surface and central orifice. Such a design allows simultaneous delivery and sonication of ingredients, beverage or a combination thereof using the central orifice.

The ultrasound transducer can also comprise a cymbal transducer. The cymbal transducer permits a broader sonication area. The cymbal transducer could be integrated into the sides of a container or method of conveyance. The cymbal transducer can further a central orifice. Such a design allows simultaneous delivery and sonication of ingredients, beverage or a combination thereof using the central orifice.

The ultrasound transducer can also be dome-shaped. The dome shape permits sonication focused at a focal point on the concave side while also allowing sonication to radiate from the convex side of the dome. The dome can further include a central orifice to allow ingredients and or beverage to travel through the dome if it were fitted a preset position in a container.

The device can further comprise a container for holding the target ingredients and beverage, which allows the placement of the ultrasound transducer at a predetermined location from the target ingredients. This may offer greater efficiency in sonicating the ingredients and beverage. A further version of the device can integrate the ultrasound transducer into the container. This allows the device to apply ultrasound energy to the targets more evenly.

A further version of the device can comprise a conveyor for conveying the target ingredients and beverage from one location to another, including possible means such as an enclosed pipe or open or partially open channel. This version permits placement of the ultrasound transducer at a predetermined location from the target ingredients. By placing the ultrasound transducer in such a manner, the apparatus can apply ultrasound energy to a much greater amount of ingredients and beverage as they flow by via the means for conveying. A further version of the device can integrate the ultrasound transducer into the means for conveying. This allows the device to apply ultrasound energy to the targets more evenly.

The ultrasound waves emitted by the apparatus can comprise a frequency at or greater than 15 kHz.

The ultrasound waves emitted by the apparatus can comprise an amplitude of at least 1 micron.

The ultrasound waves emitted by the apparatus can comprise a sinusoidal, rectangular, trapezoidal, triangular or a combination of wave forms. The increased force inherent to the rectangular form breaks down and infuses ingredients at a more efficient rate.

The ultrasound waves emitted by the apparatus can comprise continuous waves, pulsed waves, or a combination of the two.

The acoustic output emitted by the apparatus can comprise at least 0.1 W/cm2.

A method for infusing one or more ingredients with a beverage comprises placing the ingredients with beverage, placing an ultrasound transducer at a predetermined location from the ingredients, and sonicating the ingredients by applying ultrasound energy from the ultrasound transducer. The steps can occur in any order, including partially or completely simultaneously. The result of this method infuses the ingredients into the beverage with increased speed, flavor and smoothness than existing methods.

The method can further comprise the step of pulverizing the ingredients before, during or after sonication. Pulverization can save time in the duration required for sonication. In addition, pulverization can reduce the amount of energy needed for sonication, by reducing the duration of sonication, reducing the amount of energy required for sonication, or both.

The present device and method are scalable and applicable in a variety of settings, for example in a smaller device for the home, or for example a larger scale device for an industrial setting. The volume of ingredient and beverage are dependent on the amount of infused beverage needed. An example of a small scale device uses a handheld device to sonicate single or small batches of ingredient and beverage. An example of a large volume device uses a larger container and multiple ultrasound transducers. Another example of a large volume device uses multiple devices in an array to generate the desired volume.

Another example of a large volume device uses an ultrasound transducer placed at a predetermined location along a conveyor such as a pipe. The ultrasound transducer has a central orifice and interior passage fed by an ingredient delivery tube that allows ingredient to enter the ultrasound transducer and ultrasound tip and exit the central orifice located at the distal end and enter the pipe. As the ingredient exits the central orifice into the pipe, the distal end of the ultrasound transducer sonicates it. As the beverage conveys through the pipe, passing across the distal end of the ultrasound transducer, the ultrasound transducer infuses it with the ingredient exiting the central orifice using sonication.

### BRIEF DESCRIPTION OF THE DRAWINGS

The present example embodiments are shown and described with reference to the drawings and clearly understood in details.

FIG. 1 is a perspective view of an example ultrasound apparatus for producing infused beverages from ingredients and beverage.

FIG. 2 is a cross-sectional view of an example ultrasound apparatus for sonicating a mixture of ingredient and beverage in a container.

FIG. 3 is a flow chart detailing an example process for producing infused beverages from ingredients and beverage.

FIG. 4 is a flow chart detailing an example process for producing infused beverages from ingredients and beverage.

FIG. 5 is a perspective view of an example ultrasound apparatus integrating a cymbal transducer into the structure of a container for mixing ingredient and beverage.

FIG. 6 is a perspective view of an example ultrasound apparatus sonicating a mixture of ingredient and beverage in a container using multiple ultrasound transducers in multiple positions.

FIG. 7 is a cross-sectional view of an example ultrasound apparatus for producing infused beverages from ingredients and beverage while they move by a conveyance apparatus.

FIG. 8 is a cross-sectional view of an example ultrasound apparatus for producing infused beverages from ingredients and beverage while beverage, ingredients, or some combination moves by a conveyance apparatus and beverage, ingredients, or some combination is delivered through the ultrasound horn using the input delivery tube and the central orifice of the ultrasound horn.

FIG. 9 is a perspective view of an example ultrasound apparatus with a cymbal transducer for producing infused beverages from ingredients and beverage while they move by a method of conveyance.

FIG. 10 is a perspective view of an example ultrasound apparatus with a Langevin transducer for producing infused beverages from ingredients and beverage while they move by a method of conveyance.

FIG. 11 is a perspective view of an example ultrasound apparatus integrating a Langevin transducer with a pulverizing apparatus.

FIG. 12 is a perspective view of an example ultrasound apparatus for sonicating a mixture of ingredient and beverage further comprising a filter apparatus.

FIG. 13 is a cross-sectional view of an example ultrasound apparatus with a dome-shaped transducer and central orifice for producing infused beverages from ingredients and beverage.

FIG. 14 is a cross-sectional view of an example ultrasound apparatus for producing infused beverages from ingredients and beverage wherein the ultrasound transducer has a distal end with radiation surface.

### DETAILED DESCRIPTION OF THE DRAWINGS

Example embodiments are illustrated in the figures and described in detail below.

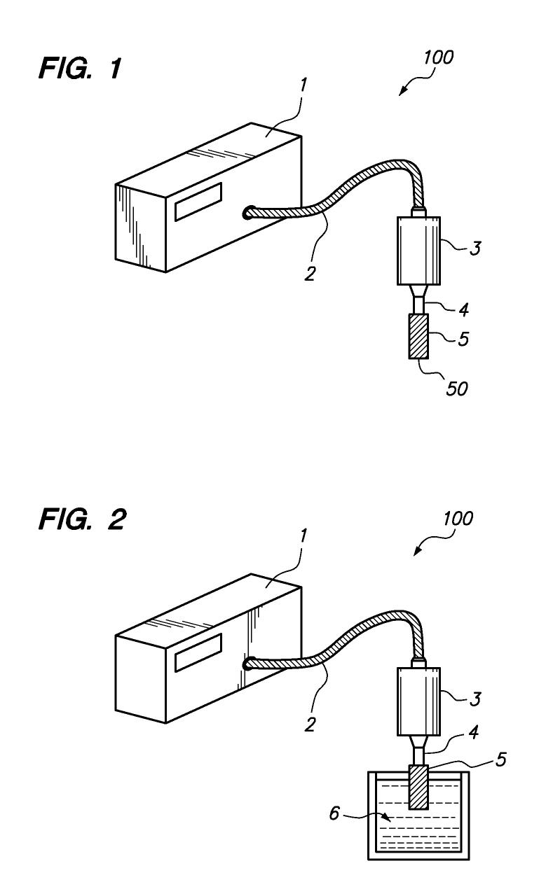

FIG. 1 is a perspective view of an example ultrasound apparatus 100 for use according to the present device and method. The ultrasound apparatus 100 is comprised of an ultrasound generator 1, a transducer cable 2, an ultrasound transducer 3, an ultrasound horn 4, and an ultrasound tip 5. The ultrasound apparatus has a distal end 50 with a radiation surface that directs ultrasound energy in a primary direction for sonication. The transducer cable 2 may be rigid or flexible. The transducer cable 2 may also bundle with other necessary cables and tubes, for example a tube for the delivery of ingredient. The ultrasound horn 4 and ultrasound tip 5 consist of ultrasound compatible materials, for example titanium, aluminum or a combination of the materials.

In keeping with FIG. 1, the shape of the distal end 50, for example the radiation surface of the distal end 50, changes the direction and focus of the delivery of ultrasound energy through sonication. The device is scalable to meet multiple environments; for example home, commercial and industrial settings. An example of a home scaled device uses a handheld ultrasound apparatus 100. An example of a commercial scaled device is a bar-mounted ultrasound apparatus 100 that allows the beverage and ingredient to be rapidly placed at a predetermined distance from the distal end 50 for rapid sonication. An example of an industrial scaled device uses a larger ultrasound apparatus 100 or an array of ultrasound apparatuses 100 that sonicate larger amounts of ingredient and beverage as desired.

FIG. 2 is a perspective view of the ultrasound apparatus 100 for infusing beverages using a container 6. The ultrasound apparatus 100 is comprised the ultrasound generator 1, the transducer cable 2, the ultrasound transducer 3, the ultrasound horn 4, and the ultrasound tip 5 placed at a predetermined location in or proximate to the container 6 containing a mixture of ingredients and beverage in order to produce an infused beverage. The ultrasound tip 5 delivers ultrasound energy to the ingredients and beverage in the container 6, infusing the ingredients and beverage and simultaneously sanitizing the ingredients and beverage.

In keeping with FIG. 2, the delivery of ultrasound energy occurs before, during or after the beverage is added to the ingredients in the container 6, or a combination thereof. An orifice (not shown) in the ultrasound tip 5 may deliver beverage, ingredient, or a combination thereof. The ultrasound tip 5 may either stay in the same position during the delivery of ultrasound energy or move during the delivery of ultrasound energy. One example of how to move the ultrasound tip 5 is by hand manipulation. Another example of how to move the ultrasound tip 5 is through automated methods, for example using a mechanism such as a plunger. One method of movement is where the ultrasound tip 5 is inserted into the bottom of the ingredients in the container 6 and then the ultrasound tip 5 gradually rises in a continuous motion as it delivers ultrasound energy. After the sonication begins, the ultrasound tip 5 gradually rises to the top of the ingredients in the container 6 while delivering ultrasound energy. The ultrasound tip 5 stops its movement and stops delivering ultrasound energy after it reaches the top of the ingredients in the container 6. Another method of movement is where the ultrasound tip 5 is inserted into the bottom of the ingredients in container 6 and then the ultrasound tip 5 rises in a step-wise motion. After the ultrasound tip 5 is inserted into the ingredients in the container 6, sonication occurs for a brief time then stops. The ultrasound tip 5 moves slightly higher, and the sonication occurs again. This step-wise motion for delivering ultrasound energy may repeat until the ultrasound tip 5 has reached the top of the ingredients in the container 6 and/or until all of the ingredients in the container 6 receive desired sonication. This distance between delivery steps in the step-wise delivery methods can be of equal or varying distances. In addition to a vertical motion, the top may move in a horizontal motion, circular motion, or a combination thereof. The motion may be continuous or step-wise. The ultrasound tip 5 may also be placed above the ingredients in the container 6 as to deliver ultrasound energy without contacting the ingredients in container 6.

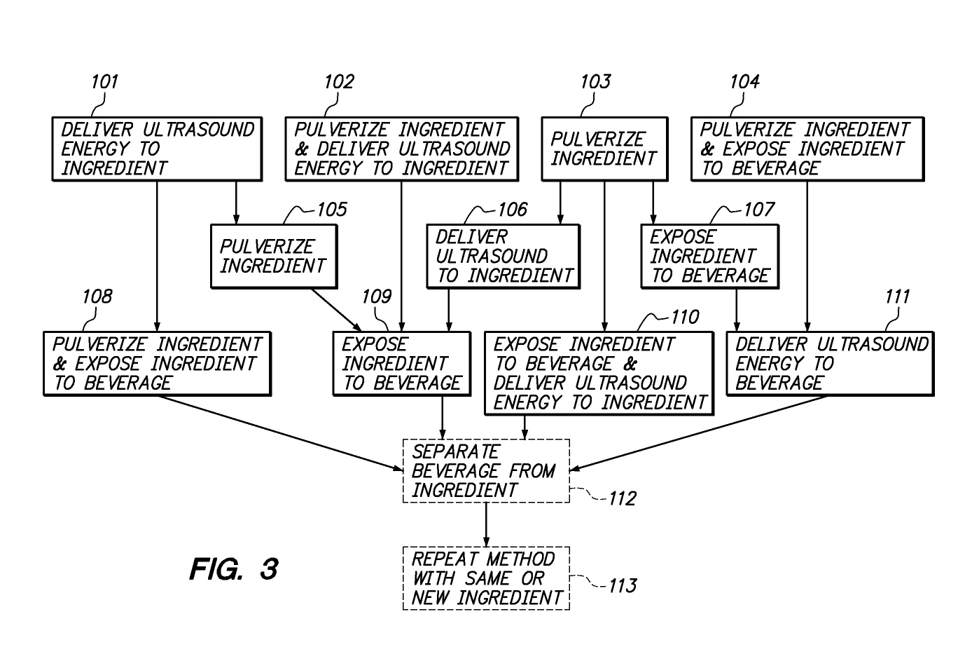

An infused beverage produced from one or more ingredients can be created as depicted by the flow chart of FIG. 3 and described in detail herein. The process begins by delivering ultrasound energy to ingredient (101), then pulverizing ingredient (105), then exposing ingredient to beverage (109). Optionally, a filter may separate beverage from ingredient (112), removing the remnants and particles from beverage. Optionally, repeat the method with the same or a new ingredient (113) as desired to create the desired flavor and intensity.

Alternatively, after delivering ultrasound energy to ingredient (101), the process continues with the simultaneous pulverizing of ingredient and exposure of ingredient to beverage (108). Optionally, a filter may separate beverage from ingredient (112), removing the remnants and particles from beverage. Optionally, repeat the method with the same or a new ingredient (113) as desired to create the desired flavor and intensity.

Alternatively, the process begins by simultaneously pulverizing ingredient and delivering ultrasound energy to ingredient (102), then exposing ingredient to beverage (109). Optionally, a filter may separate beverage from ingredient (112), removing the remnants and particles from beverage. Optionally, repeat the method with the same or a new ingredient (113) as desired to create the desired flavor and intensity.

Alternatively, the process begins with pulverizing ingredient (103), then delivering ultrasound energy to ingredient (106), then exposing ingredient to beverage (109). Optionally, a filter may separate beverage from ingredient (112), removing the remnants and particles from beverage. Optionally, repeat the method with the same or a new ingredient (113) as desired to create the desired flavor and intensity.

Alternatively, after pulverizing ingredient (103), the process continues with the simultaneous exposure of ingredient to beverage and delivering ultrasound energy to ingredient (110). Optionally, a filter may separate beverage from ingredient (112), removing the remnants and particles from beverage. Optionally, repeat the method with the same or a new ingredient (113) as desired to create the desired flavor and intensity.

Alternatively, after pulverizing ingredient (103), the process continues by exposing ingredient to beverage (107), then delivering ultrasound energy to beverage (111). Optionally, a filter may separate beverage from ingredient (112), removing the remnants and particles from beverage. Optionally, repeat the method with the same or a new ingredient (113) as desired to create the desired flavor and intensity.

Alternatively, the process begins with simultaneously pulverizing ingredient and exposing ingredient to beverage (104), then delivering ultrasound energy to beverage (111). Optionally, a filter may separate beverage from ingredient (112), removing the remnants and particles from beverage. Optionally, repeat the method with the same or a new ingredient (113) as desired to create the desired flavor and intensity.

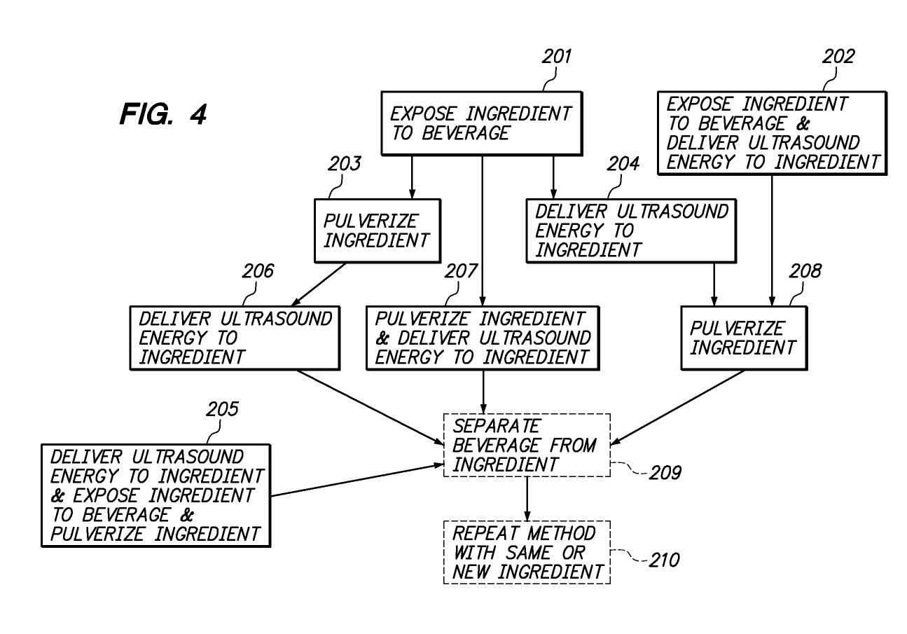

FIG. 4 is a flow chart detailing additional alternative processes for producing infused beverages from ingredients and beverage. The process begins by exposing ingredient to beverage (201), then pulverizing ingredient (203), then delivering ultrasound energy to ingredient (206). Optionally, a filter may separate beverage from ingredient (209), removing the remnants and particles from beverage. Optionally, repeat the method with the same or a new ingredient (210) as desired to create the desired flavor and intensity.

Alternatively, after exposing the ingredient to the beverage (201), the process continues with the simultaneous pulverization of ingredient and delivery of ultrasound energy to ingredient (207). Optionally, a filter may separate beverage from ingredient (209), removing the remnants and particles from beverage. Optionally, repeat the method with the same or a new ingredient (210) as desired to create the desired flavor and intensity.

Alternatively, after exposing the ingredient to the beverage (201), the process continues by delivering ultrasound energy to ingredient (204), then pulverizing ingredient (208). Optionally, a filter may separate beverage from ingredient (209), removing the remnants and particles from beverage. Optionally, repeat the method with the same or a new ingredient (210) as desired to create the desired flavor and intensity.

Alternatively, the process begins with simultaneously exposing ingredient to beverage and delivering ultrasound energy to ingredient (202), then pulverizing ingredient (208). Optionally, a filter may separate beverage from ingredient (209), removing the remnants and particles from beverage. Optionally, repeat the method with the same or a new ingredient (210) as desired to create the desired flavor and intensity.

Alternatively, the process begins with simultaneously delivering ultrasound energy to ingredient and exposing ingredient to beverage and pulverizing ingredient (205). Optionally, a filter may separate beverage from ingredient 209, removing the remnants and particles from beverage. Optionally, repeat the method with the same or a new ingredient 210 as desired to create the desired flavor and intensity.

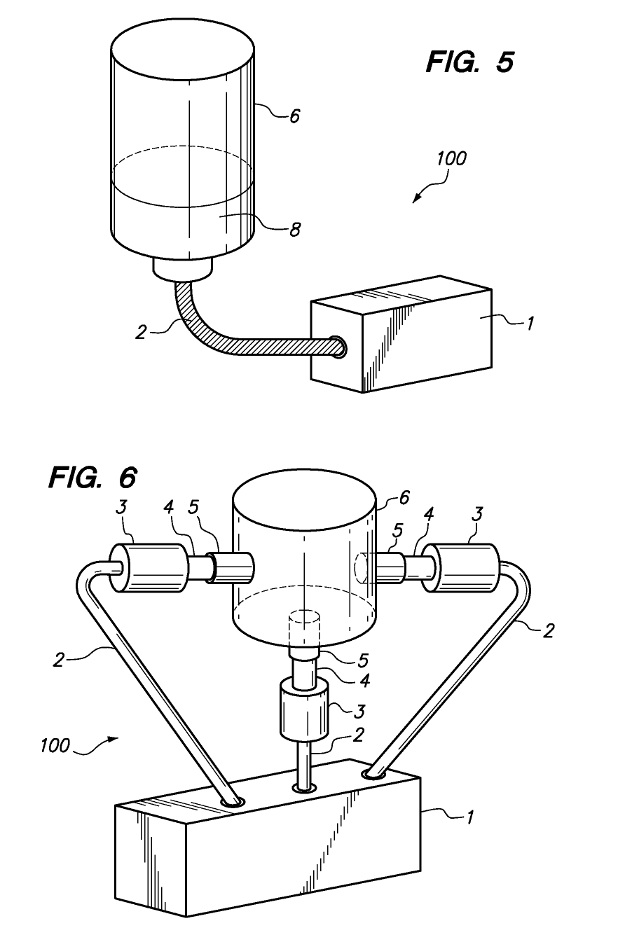

FIG. 5 is a perspective view of an example ultrasound apparatus 100 integrating a cymbal transducer 8 into the structure of the container 6 for mixing ingredient and beverage. The ultrasound apparatus 100 is comprised of the ultrasound generator 1, the transducer cable 2, and the ultrasound cymbal transducer 8. The cymbal transducer 8 is integrated into the structure of the container 6 for mixing ingredient and beverage. The cymbal transducer 8 delivers ultrasound energy to the ingredients and beverage in the container 6, infusing the ingredients and beverage and simultaneously sanitizing the ingredients and beverage. In keeping with FIG. 5, ultrasound energy can be delivered before, during or after the beverage is added to the ingredients in the container 6, or a combination thereof. An orifice (not shown) in the cymbal transducer 8 may deliver ingredients, beverage or a combination thereof.

FIG. 6 is a perspective view of an example ultrasound apparatus 100 sonicating a mixture of ingredient and beverage in the container 6 using multiple ultrasound tips 5 in multiple positions. The ultrasound apparatus 100 is comprised an ultrasound generator 1, the transducer cables 2, the ultrasound transducers 3, the ultrasound horns 4, and the ultrasound tips 5 placed at a predetermined locations integrated in or proximate to the container 6 containing a mixture of ingredients and beverage in order to produce an infused beverage. The ultrasound tips 5 deliver ultrasound energy to the ingredients and beverage in the container 6 from multiple directions and angles, infusing the ingredients and beverage and simultaneously sanitizing the ingredients and beverage.

In keeping with FIG. 6, the delivery of ultrasound energy occurs before, during or after the beverage is added to the ingredients in the container 6, or a combination thereof. An orifice (not shown) in any or all the ultrasound tips 5 may deliver ingredients, beverage or a combination thereof. Ultrasound energy can be delivered by all the ultrasound tips 5 at once, each at a time, or in some combination. The ultrasound tips 5 may either stay in the same position during the delivery of ultrasound energy or may move during the delivery of ultrasound energy. The ultrasound tips 5 may either move during the delivery of ultrasound energy or only some. A part of the container 6 that integrates the ultrasound tip 5 may be designed to move. One method is where the ultrasound tip 5 is integrated into a circular wall of the container 6 and then the wall turns to move the position of the ultrasound tip 5.

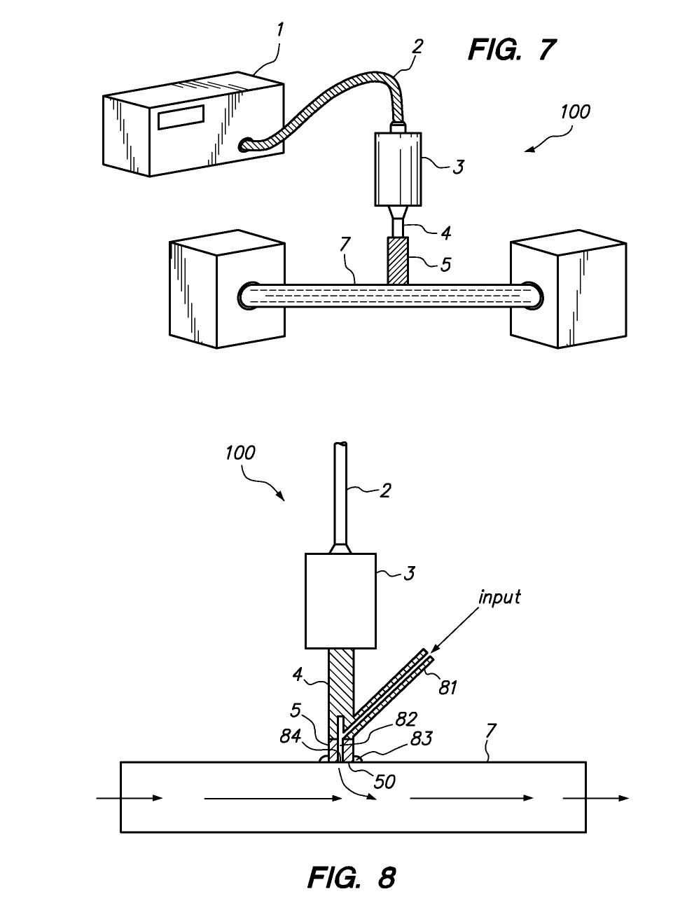

FIG. 7 is a cross-sectional view of an ultrasound apparatus 100 for producing infused beverages from ingredients and beverage while they move by the conveyance apparatus 7. The ultrasound apparatus 100 is comprised the ultrasound generator 1, the transducer cable 2, the ultrasound transducer 3, the ultrasound horn 4, and the ultrasound tip 5 placed at a predetermined location in or proximate to the conveyance apparatus 7 containing a mixture of ingredients and beverage in order to produce an infused beverage. The ultrasound tip 5 delivers ultrasound energy to the ingredients and beverage in the conveyance apparatus 7, infusing the ingredients and beverage and simultaneously sanitizing the ingredients and beverage. An example of a conveyance apparatus 7 comprises tubes or pipes. The flow of ingredients, beverage, or a combination thereof through the conveyance apparatus 7 may be controlled by mechanical means, gravity feed, hydraulic pressure, ultrasound pressure or a combination thereof.

In keeping with FIG. 7, an orifice (not shown) in the ultrasound tip 5 may deliver ingredients, beverage or a combination thereof. The ultrasound tip 5 may either stay in the same position during the delivery of ultrasound energy or may move during the delivery of ultrasound energy.

FIG. 8 is a cross-sectional view of an ultrasound apparatus 100 for producing infused beverages from ingredients and beverage while beverage, ingredients, or some combination moves by the conveyance apparatus 7 and beverage, ingredients, or some combination is delivered through the ultrasound horn 4 using the input delivery tube 81 and the central orifice 84 of the ultrasound horn 4. The ultrasound apparatus 100 comprises the ultrasound generator (not shown), the transducer cable 2, the ultrasound transducer 3, the ultrasound horn 4, the ultrasound tip 5 with a distal end 50, the input delivery tube 81, the interior passage 82, the central orifice 84, the vibration damper 83 placed at a predetermined location in or proximate to the conveyance apparatus 7. While beverage, ingredients, or some combination moves via the conveyance apparatus 7, the input delivery tube 81 delivers beverage, ingredients, or some combination into the interior passage 82 of the ultrasound horn 4 and ultrasound tip 5; the beverage, ingredients, or some combination exits the interior passage 82 via the central orifice 84 of the distal end 50 into the conveyance apparatus 7. The ultrasound transducer 3, the ultrasound horn 4, and the ultrasound tip 5 sonicate the beverage, ingredients, or some combination as they travel via the input delivery tube 81 and the interior passage 82 and exit via the central orifice 84 into the conveyer apparatus 7. The ultrasound transducer 3, the ultrasound horn 4, and the ultrasound tip 5 may deliver ultrasound energy to the ingredients and beverage while the beverage, ingredients, or some combination travel via the input delivery tube 81 and the interior passage 82 and exit via the central orifice 84 of the distal end 50 into the conveyer apparatus 7, after they exit the central orifice 84 of the distal end 50 and enter the conveyer apparatus 7, or a combination of the two, infusing the ingredients and beverage and simultaneously sanitizing the ingredients and beverage. The flow of ingredients, beverage, or a combination thereof through the input delivery tube 81 and the interior passage 82 and exit via the central orifice 84 of the distal end 50 into the conveyer apparatus 7 may be controlled by mechanical means, gravity feed, hydraulic pressure, ultrasound pressure or a combination thereof. The addition of the vibration damper 83 reduces the amount of ultrasound energy and vibration transmitted from the ultrasound apparatus 100, for example at the point of the ultrasound tip 5, to the conveyance apparatus 7. The reduction of vibrations being transmitted to the conveyance apparatus 7 may reduce structural fatigue brought on by ultrasound energy and vibration and extend the useable life of the conveyance apparatus 7. The vibration damper 83 may be made out of a material conducive to absorbing ultrasound energy and vibrations, for example rubber. The device in FIG. 8 is scalable to meet multiple environments; for example home, commercial and industrial settings. An example of an industrial scaled device uses a larger ultrasound apparatus 100, an array of ultrasound apparatuses 100 or a combination attached to a larger conveyor apparatus 7, multiple conveyor apparatuses 7, or a combination to sonicate larger amounts of ingredient and beverage as desired. An example of a conveyance apparatus 7 comprises tubes or pipes. The flow of ingredients, beverage, or a combination thereof through the conveyance apparatus 7 may be controlled by mechanical means, gravity feed, hydraulic pressure, ultrasound pressure or a combination thereof.

In keeping with FIG. 8, the input delivery tube 81 may be part of the same single piece as the ultrasound transducer 3, the ultrasound horn 4, the ultrasound tip 5, or a combination thereof. The input delivery tube 81 may be a separate piece connected to the ultrasound transducer 3, the ultrasound horn 4, the ultrasound tip 5, or a combination thereof by chemical bonding with an adhesive, by soldering, by welding, or a combination thereof. The input delivery tube 81 may be mechanically connected to the ultrasound transducer 3, the ultrasound horn 4, the ultrasound tip 5, or a combination thereof by threading or other means.

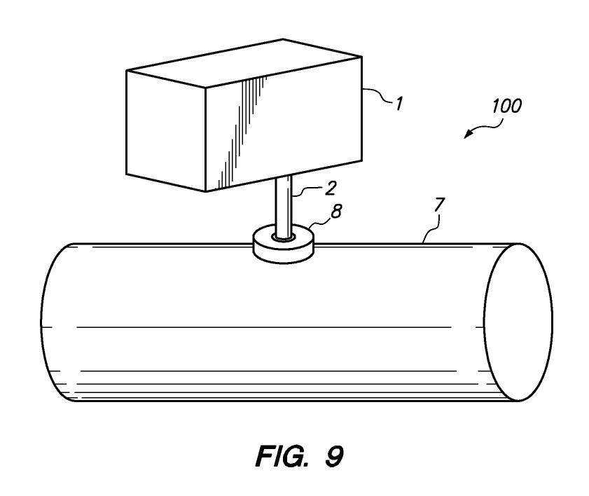

FIG. 9 is a perspective view of an example ultrasound apparatus 100 with the cymbal transducer 8 for producing infused beverages from ingredients and beverage while they move by the conveyance apparatus 7. The ultrasound apparatus 100 is comprised the ultrasound generator 1, the transducer cable 2, and the ultrasound cymbal transducer 8 which is integrated into the structure of the conveyance apparatus 7 containing a mixture of ingredients and beverage in order to produce an infused beverage. The cymbal transducer 8 delivers ultrasound energy to the ingredients and beverage in the conveyance apparatus 7, infusing the ingredients and beverage and simultaneously sanitizing the ingredients and beverage. An example of a conveyance apparatus 7 comprises tubes or pipes. The flow of ingredients, beverage, or a combination thereof through the conveyance apparatus 7 may be controlled by mechanical means, gravity feed, hydraulic pressure, ultrasound pressure or a combination thereof.

In keeping with FIG. 9, an orifice (not shown) in the cymbal transducer 8 may deliver ingredients, beverage or a combination thereof. The cymbal transducer 8 may either stay in the same position during the delivery of ultrasound energy or may move during the delivery of ultrasound energy.

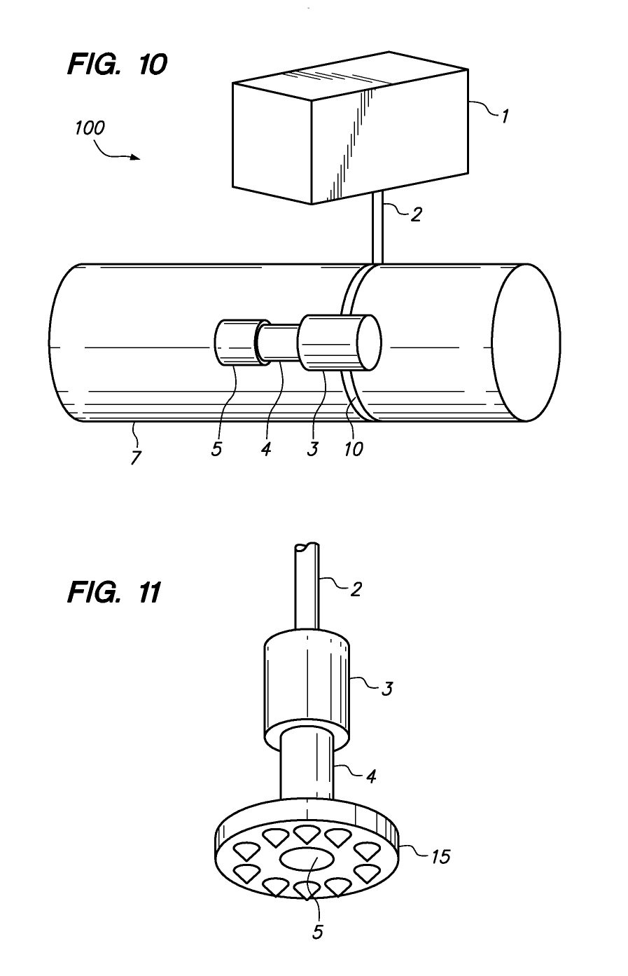

FIG. 10 is a perspective view of an example ultrasound apparatus 100 for producing infused beverages from ingredients and beverage while they move by the conveyance apparatus 7. The ultrasound apparatus 100 is comprised the ultrasound generator 1, the transducer cable 2, a support bracket apparatus 10, the ultrasound transducer 3, the ultrasound horn 4, and the ultrasound tip 5 placed at a predetermined location inside the conveyance apparatus 7 containing a mixture of ingredients and beverage in order to produce an infused beverage. The transducer cable 2 may be located within the support bracket apparatus 10, outside the support bracket apparatus 10, or a combination thereof. The ultrasound tip 5 delivers ultrasound energy to the ingredients and beverage in the conveyance apparatus 7, infusing the ingredients and beverage and simultaneously sanitizing the ingredients and beverage. An example of a conveyance apparatus 7 comprises tubes or pipes. The flow of ingredients, beverage, or a combination thereof through the conveyance apparatus 7 may be controlled by mechanical means, gravity feed, hydraulic pressure, ultrasound pressure or a combination thereof. The direction of the mixture of ingredients and beverage may flow in either direction.

In keeping with FIG. 10, an orifice (not shown) in the ultrasound tip 5 may deliver ingredients, beverage or a combination thereof. The ultrasound tip 5 may either stay in the same position during the delivery of ultrasound energy or may move during the delivery of ultrasound energy.

FIG. 11 is a perspective view of an example ultrasound apparatus 100 integrating the ultrasound transducer 3 and the ultrasound tip 4 with a pulverizing apparatus 15. The ultrasound apparatus 100 is comprised the ultrasound generator (not shown), the transducer cable 2, the ultrasound transducer 3, the ultrasound horn 4, the ultrasound tip 5 and the pulverizing apparatus 15. The ultrasound tip 5 delivers ultrasound energy to the ingredients and beverage, infusing the ingredients and beverage and simultaneously sanitizing the ingredients and beverage. The pulverizing apparatus 15 pulverizes ingredients, breaking them into pieces that are sonicated by ultrasound energy delivered by the ultrasound tip 5. The pulverizing apparatus 15 may be part of the same single piece as the ultrasound transducer 3, the ultrasound horn 4, the ultrasound tip 5, or a combination thereof. The pulverizing apparatus 15 may be a separate piece connected to the ultrasound transducer 3, the ultrasound horn 4, the ultrasound tip 5, or a combination thereof by chemical bonding with an adhesive, by soldering, by welding, or a combination thereof. The pulverizing apparatus 15 may be mechanically connected to the ultrasound transducer 3, the ultrasound horn 4, the ultrasound tip 5, or a combination thereof by threading or other means.

In keeping with FIG. 11, the delivery of ultrasound energy occurs before, during or after the ingredients are pulverized by the pulverizing apparatus 15, or a combination thereof. An orifice (not shown) in the ultrasound tip 5 may deliver ingredients, beverage or a combination thereof. An orifice (not shown) in the pulverizing apparatus 15 may deliver ingredients, beverage or a combination thereof. The ultrasound tip 5 may either stay in the same position during the delivery of ultrasound energy or may move during the delivery of ultrasound energy. The ultrasound tip 5 may either move during the delivery of ultrasound energy or only some.

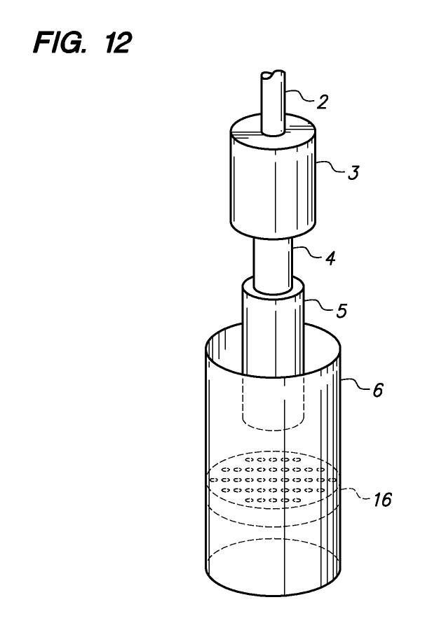

FIG. 12 is a perspective view of an example ultrasound apparatus 100 for delivering ultrasound energy to a mixture of ingredient and beverage further comprising a filter apparatus 16. The ultrasound apparatus 100 is comprised the ultrasound generator (not shown), the transducer cable 2, the ultrasound transducer 3, the ultrasound horn 4, the ultrasound tip 5 placed at a predetermined location in or proximate to the container 6 containing a mixture of ingredients and beverage, and the filter apparatus 16 in order to produce an infused beverage. The ultrasound tip 5 delivers ultrasound energy to the ingredients and beverage, infusing the ingredients and beverage and simultaneously sanitizing the ingredients and beverage. The filter apparatus 16 filters ingredients, beverage, or a combination thereof, removing debris larger than a predetermined size. An example of a filter apparatus 16 is a semi-permeable barrier such as a mesh. An example of a filter apparatus 16 is a semi-permeable barrier such as a solid, flexible or combination of the two, membrane consisting of metal, plastic or a combination of the two, with perforations set at predetermined sizes that allow ingredients, beverage, or a combination thereof to pass through while blocking and retaining the desired size of debris. Another example of a filter apparatus 16 is a single perforated layer (a sieve) that prevents debris larger than a predetermined size from passing through the holes of the sieve, retaining them. Another example of a filter apparatus 16 is a multilayer lattice consisting of multiple perforated layers that prevent debris larger than a predetermined size from passing through the holes of the multilayer lattice, retaining them. An example device may use multiple filter apparatuses 16 of various size, types, shapes, or a combination thereof.

In keeping with FIG. 12, the delivery of ultrasound energy occurs before, during or after the ingredients are filtered by the filtering apparatus 16, or a combination thereof. An orifice (not shown) in the ultrasound tip 5 may deliver ingredients, beverage or a combination thereof. An orifice (not shown) in the filter apparatus 16 may deliver ingredients, beverage or a combination thereof. The ultrasound tip 5 may either stay in the same position during the delivery of ultrasound energy or may move during the delivery of ultrasound energy. The ultrasound tip 5 may either move during the delivery of ultrasound energy or only some.

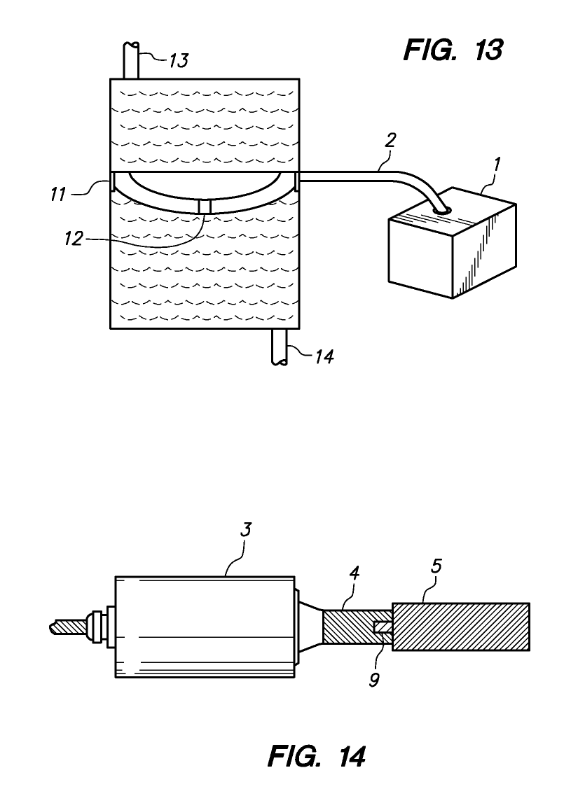

FIG. 13 is a partial cross-sectional view of an ultrasound apparatus 100 with a dome-shaped transducer 11 and the central orifice 12 for producing infused beverages from ingredients and beverage. The ultrasound apparatus 100 is comprised the ultrasound generator 1, the transducer cable 2, the dome-shaped transducer 11 with a central orifice 12 placed at a predetermined location in the container 6 that includes both an inflow 13 and outflow 14 for ingredients, beverage, or a combination thereof. Ingredients, beverage, or a combination thereof enter the container 6 via the inflow 13. The dome-shaped transducer 11 delivers ultrasound energy to ingredients, beverage, or a combination thereof. The shape of the concave side of the dome-shaped transducer 11 delivers focused ultrasound energy on a predetermined point while also delivering ultrasound energy to the surrounding areas. The resulting sonicated infused beverage passes through the central orifice 12. The size of the central orifice 12 can have a filtering effect on the size of what passes through. As the infused beverage moves towards the outflow 14, the convex side of the dome-shaped transducer 11 delivers ultrasound energy to the infused beverage. The infused beverage then leaves the container 6 via the outflow 13. The flow of ingredients, beverage, or a combination thereof from inflow 13 to outflow 14 may be controlled by mechanical means, gravity feed, hydraulic pressure, ultrasound pressure or a combination thereof.

In keeping with FIG. 13, the delivery of ultrasound energy occurs before, during or after the ingredients are filtered by the central orifice 12, or a combination thereof.

FIG. 14 is a partial cross-sectional view of the ultrasound apparatus 100 shown in FIG. 1. The ultrasound apparatus is comprised of the ultrasound transducer 3, and the ultrasound horn 4, and the ultrasound tip 5. The ultrasound horn 4, is mechanically connected to the ultrasound tip 5, by threading or other means 9. Alternative embodiments could have the ultrasound tip 5 directly connected to the ultrasound horn 4 to comprise a single piece without a mechanical interface. Alternatively, the ultrasound tip 5 could be connected to the ultrasound horn 4 by chemical bonding with an adhesive, by soldering, by welding, or a combination thereof. The ultrasound transducer 3 is directly connected to the ultrasound horn 4; alternative embodiments could have the ultrasound transducer 3 mechanically connected to the ultrasound horn 4 by threading or other means. The ultrasound transducer 3 and the horn 4 may also be connected by chemical bonding with an adhesive, by soldering, by welding, or a combination thereof.

I claim:

1. An apparatus for producing infused beverages using ultrasound energy, comprising:
a tip;
a horn;
an ultrasound transducer that sonicates one or more target ingredients and beverage, and
a generator that provides energy to power the ultrasound transducer,
whereby the apparatus uses ultrasound energy to infuse the target ingredients and beverage.

2. The apparatus of claim 1, further comprising a container for holding the target ingredients and beverage,
whereby the ultrasound transducer disposed at a predetermined location from the target ingredients.

3. The apparatus of claim 2 wherein the ultrasound transducer is integrated into the container.

4. The apparatus of claim 1, further comprising a conveyance apparatus for conveying the target ingredients and beverage from one location to another,
whereby the ultrasound transducer is placed at a predetermined location from the target ingredients.

5. The apparatus of claim 4 wherein the ultrasound transducer is integrated into the conveyance apparatus.

6. The apparatus of claim 1, further comprising a pulverizing apparatus for pulverizing the target ingredients.

7. The apparatus of claim 6 wherein the ultrasound transducer is integrated into the pulverizing apparatus.

8. The apparatus of claim 1, further comprising a filter apparatus that filters ingredients, beverage, or a combination thereof.

9. The apparatus of claim 8 wherein the ultrasound transducer is integrated into the filter apparatus.

10. The apparatus of claim 1 wherein the ultrasound transducer comprises a distal end with a radiation surface.

11. The apparatus of claim 10 wherein the ultrasound transducer has a central orifice to deliver ingredients, beverage, or a combination thereof.

12. The apparatus of claim 1 wherein the ultrasound transducer is a cymbal transducer.

13. The apparatus of claim 12 wherein the cymbal transducer has a central orifice to deliver ingredients, beverage, or a combination thereof.

14. The apparatus of claim 1 wherein the ultrasound transducer is dome shaped.

15. The apparatus of claim 14 wherein the dome has a central orifice to deliver ingredients, beverage, or a combination thereof.

16. The apparatus of claim 1 wherein the ultrasound waves emitted comprise a frequency at or greater than 15 kHz.

17. The apparatus of claim 1 wherein the ultrasound waves emitted comprise an amplitude of at least 1 micron.

18. The apparatus of claim 1 wherein the signal form of ultrasound waves emitted comprise a sinusoidal, rectangular, trapezoidal, triangular or a combination of wave forms.

19. The apparatus of claim 1 wherein the type of ultrasound waves emitted comprise continuous waves, pulsed waves, or a combination of the two.

20. The apparatus of claim 1 wherein the acoustic output emitted comprise of at least 0.1 W/cm2.

21. A method for infusing one or more ingredients with a beverage, comprising:
exposing the ingredients to the beverage,
placing an ultrasound transducer at a predetermined distance from the ingredients, and
sonicating the ingredients by delivering ultrasound energy from the ultrasound transducer,
whereby the ingredients will be infused with the beverage.

22. The method according to claim 21, wherein the delivery of ultrasound energy to ingredients occurs concurrently with the exposure of ingredients to a beverage.

23. The method according to claim 21, wherein the delivery of ultrasound energy to ingredients occurs prior to the exposure of ingredients to a beverage.

24. The method according to claim 21, further comprising separating the beverage from the ingredients.

25. The method according to claim 21, wherein the separation of the beverage from the ingredients comprises filtering the ingredients from the beverage.

26. The method according to claim 21, further comprising pulverizing the ingredients prior to the sonication.

27. The method according to claim 21, further comprising pulverizing the ingredients during the sonication.

28. The method according to claim 21, further comprising pulverizing the ingredients after the sonication.

29. The method according to claim 21, further comprising a central orifice to deliver ingredients, beverage, or a combination thereof.
